(19) United States
(12) Patent Application Publication
(10) Pub. No.: US 2013/0297413 A1
(43) Pub. Date: Nov. 7, 2013

(54) USING ACTIONS TO SELECT ADVERTISEMENTS

(71) Applicant: Neha Pattan, Mountain View, CA (US)

(72) Inventor: Neha Pattan, Mountain View, CA (US)

(73) Assignee: Google Inc.

(21) Appl. No.: 13/463,554

(22) Filed: May 3, 2012

(51) Int. Cl. G06Q 30/02

(52) U.S. Cl. 705/14.49

(57) ABSTRACT

Systems and methods for providing an advertisement based on an action directed by a first user to a second user including receiving, using one or more computing devices, a request from a first user directed to a second user, wherein the request comprises a second user identifier and an action tag; generating a suggested advertisement based at least on data that is part of the request; identifying the request from the first user to determine whether the suggested advertisement matches the request; selecting the matching advertisement as a candidate advertisement for presentation to the second user; and providing a candidate advertisement to the second user.

### BACKGROUND

Disclosure herein relates to online advertising, and more specifically to using online actions directed from one user to another user to select advertisements. In a social networking environment, users can interact and share various content with each other. For many social networking applications, games play an integral role for interaction between users. Actions and annotations from the game may be useful for advertisers or publishers to provide relevant advertisements to the users

### SUMMARY

Implementations of the systems and methods for providing an advertisement based on an action directed by a first user to a second user are described herein. One implementation is a method for providing an advertisement based on an action directed by a first user to a second user. The method may include receiving a request from a first user directed to a second user, wherein the request comprises a second user identifier and an action tag, the action tag representative of an action directed by the first user to the second user. The method may also include generating a candidate advertisement based at least on data that is part of the request. The method may also include sending the candidate advertisement to an advertisement mixer, the advertisement mixer configured to receive a request for an advertisement. The method may further include selecting, using the advertisement mixer, an advertisement from among a plurality of candidate advertisements for presentation to the second user. The method may also include providing the selected advertisement to the second user.

Another implementation is a system for providing an advertisement based on an action directed by a first user to a second user. The system may include a tangible computer-readable storage device comprising instructions; and one or more processors coupled to the non-transitory computer-readable storage device and configured to execute the instructions to perform operations for receiving a request from a first user directed to a second user, wherein the request comprises a second user identifier and an action tag, the action tag representative of an action directed by the first user to the second user. The operations may also include generating a candidate advertisement based at least on data that is part of the request. The operations may further include sending the candidate advertisement to an advertisement mixer, the advertisement mixer configured to receive a request for an advertisement. The operations may include selecting, using the advertisement mixer, an advertisement from among a plurality of candidate advertisements for presentation to the second user. The method may further include providing the selected advertisement to the second user.

The details of one or more implementations of the disclosure are set forth in the accompanying drawings and the description below. Other features, aspects, and advantages of the disclosure will become apparent from the description, the drawings, and the claims.

### BRIEF DESCRIPTION OF THE DRAWINGS

FIG. 1 illustrates a computer system in accordance with a described implementation;

FIG. 2 illustrates a block diagram of an application providing identifiers according to a described implementation;

FIG. 3 illustrates a display of a user interface in accordance with a described implementation;

FIG. 4 illustrates a display of a user interface in accordance with a described implementation;

FIG. 5 illustrates a server system for storing information in accordance with a described implementation;

FIG. 6 illustrates a block diagram of an advertisement serving system in accordance with a described implementation;

FIG. 7 illustrates a display of a web page providing an annotated advertisement in accordance with a described implementation;

FIG. 8 is a flow diagram of a method in accordance with a described implementation; and

FIG. 9 is a block diagram of devices that may be used to implement the systems and methods in accordance with the described implementations.

### DETAILED DESCRIPTION

### Overview

The present disclosure relates generally to systems and methods for selecting advertisements and more particularly, to using actions directed from one user to another user to select advertisements. For example, users of computing devices may interact with one another, such as about a game that one of the users is currently playing. It may be useful for advertisers to use actions and annotations from the game and/or social network to provide relevant advertisements to all parties interacting.

Games and social media may engage many users, especially in the context of mobile computing devices, e.g., smartphones. Integrating games and social media with advertising may improve metrics for online advertising, such as click-through rate (CTR), conversions, etc. Implementations described herein use actions (e.g., invites, challenges, etc.) from social networking applications within games (or gaming applications with access to social networks), annotations (e.g., rating input) to select, generate and provide relevant advertisements. The advertisement, along with action and annotation, may be displayed via a content network (e.g., a social networking web page) and/or a search network (e.g., alongside search results). The implementations described herein may improve the relevancy of advertisements by personalizing the advertisements based on social signals, such as actions and annotations.

### Example Systems

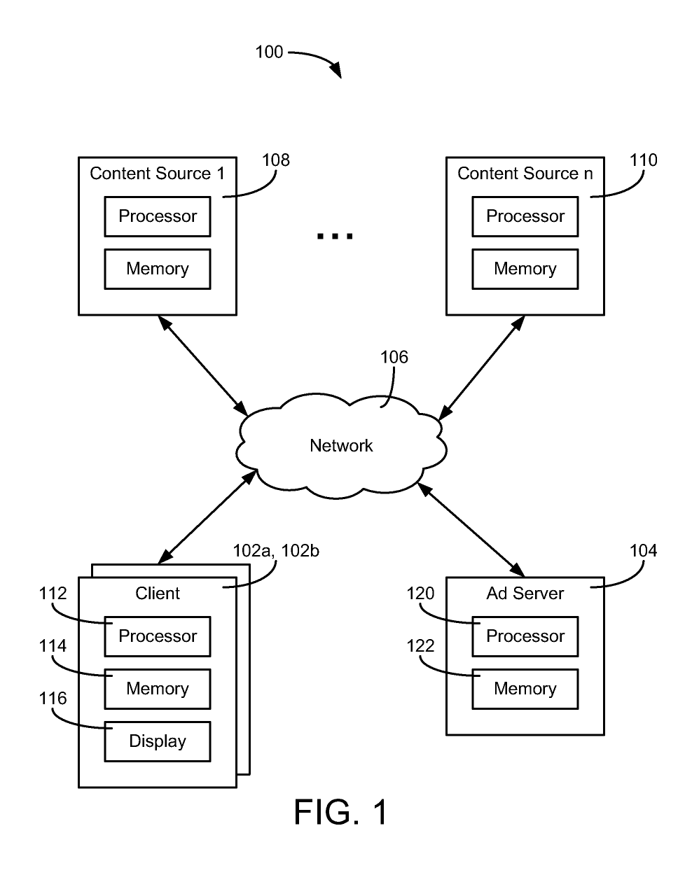

Referring to FIG. 1, a block diagram of a computer system 100 in accordance with a described implementation is shown. System 100 includes clients 102a, 102b which communicate with other computing devices via a network 106. For example, clients 102a, 102b may communicate with one or more content sources ranging from a first content source 108 up to an nth content source 110. Content sources 108, 110 may provide webpages and/or media content (e.g., audio, video, and other forms of digital content) to clients 102a, 102b. System 100 may also include an advertisement server 104, which provides advertisement data to other computing devices over network 106.

Network 106 may be any form of computer network that relays information between clients 102a, 102b, advertisement server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, clients 102a, 102b may communicate wirelessly (e.g., via WiFi, cellular, radio, etc.) with a transceiver that is hardwired (e.g., via a fiber optic cable, a CAT5 cable, etc.) to other computing devices in network 106.

Clients 102a, 102b may be any number of different user electronic devices configured to communicate via network 106 (e.g., a laptop computer, a desktop computer, a tablet computer, a smartphone, a digital video recorder, a set-top box for a television, a television with one or more processors embedded therein, a video game console, etc.). Clients 102a, 102b are shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., and/or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Clients 102a, 102b may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of clients 102a, 102b (e.g., a built-in display, microphone, etc.) or external to the housing of clients 102a, 102b (e.g., a monitor connected to clients 102a, 102b, a speaker connected to clients 102a, 102b, etc.), according to various implementations. For example, clients 102a, 102b may include an electronic display 116, which visually displays webpages using webpage data received from content sources 108, 110 and/or from advertisement server 104.

Content sources 108, 110 are electronic devices connected to network 106 and provide media content to clients 102a, 102b. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data. Similarly, advertisement server 104 may include a processing circuit including a processor 120 and a memory 122. In some implementations, advertisement server 104 may include several computing devices (e.g., a data center, a network of servers, etc.). In such a case, the various devices of advertisement server 104 may be in electronic communication, thereby also forming a processing circuit (e.g., processor 120 includes the collective processors of the devices and memory 122 includes the collective memories of the devices).

Advertisement server 104 may provide digital advertisements to clients 102a, 102b via network 106. For example, content source 108 may provide a webpage to clients 102a, 102b, in response to receiving a request for a webpage from clients 102a, 102b. In some implementations, an advertisement from advertisement server 104 may be provided to clients 102a, 102b indirectly. For example, content source 108 may receive advertisement data from advertisement server 104 and use the advertisement as part of the webpage data provided to clients 102a, 102b. In other implementations, an advertisement from advertisement server 104 may be provided to clients 102a, 102b directly. For example, content source 108 may provide webpage data to clients 102a, 102b that includes a command to retrieve an advertisement from advertisement server 104. On receipt of the webpage data, clients 102a, 102b may retrieve an advertisement from advertisement server 104 based on the command and display the advertisement when the webpage is rendered on display 116.

According to various implementations, advertisement server 104 may provide an advertisement to client 102a based in part on data provided by another user (e.g., client 102b). In some implementations, advertisement server 104 may use an auction model that generates an advertisement for client 102b based at least on matching an advertiser's creative with an action tag, user identifier, etc. provided by client 102a. For example, a user may challenge another user to reach a certain level within the game, which may be provided to the advertisement server 104 via client device 102a. A relevant advertisement including the user's challenge may be displayed on client device 102b. As part of the advertisement selection process, advertisement server 104 may determine one or more characteristics of the action tag and use the model to provide a relevant advertisement.

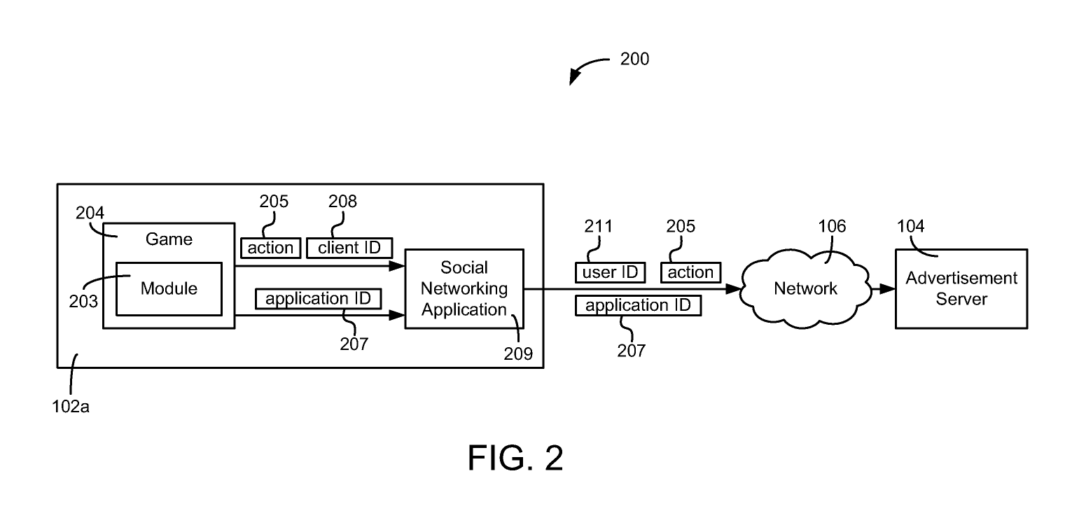

FIG. 2 illustrates a block diagram of system 200 for providing information to advertisement server 104 via client device 102a. System 200 may include, but is not limited to, client device 102a, network 106, and advertisement server 104. Client device 102a may include game application 204, which may include module 203 for storing and transferring information (e.g., interfacing) to social networking application 209.

In some implementations, other applications may be provided with one or more of the features described herein, such as a music playing application, a video playing application, productivity applications, education applications, finance applications, health and fitness applications, news applications, sports applications, weather applications, travel applications, etc.

Game application 204 may provide advertisement requests to advertisement server 104. Game application 204 may receive advertisements related to the game, receive advertisements related to other content, provide annotations and/or actions to social networking application 209 or another application, etc. In some implementations, social networking application 209 runs on client device 102a to engage with the social network via applications provided by a server. In another implementation, social networking application 209 may run on one or more computing devices (e.g., a server). Client device 102a may access the social network via a web browser, having functionality to facilitate the interaction, e.g., JavaScript. Game application 204 may also include a web browsing feature for receiving webpages and other related content. Each application on client device 102a may include an application identifier.

Referring to FIG. 2, the user may play a game using game application 204 on client device 102a. Game application 204 may include an interactive function, such as module 203, to provide actions to other users. The other users may include users of the game, users of a social networking website, etc. Module 203 performs the functionality of generating action 205, client identifier 208, and application identifier 207 by collecting information from the client device 102a. Module 203 may also include an application programming interface (API) that may transmit action 205, client identifier 208, and application identifier 207 to social networking application 209. In some implementations, social networking application 209 acts as a background service. For example, social networking application 209 listens for calls from module 203 for intents. An intent is a data structure that includes a general (abstract) description of the operation to be performed. For example, any activity, service, and other core components of applications may be activated by an intent. In some implementations, the intent may include action 205. The intent may provide the system with information about the action to be taken and the data to act on. For example, the intent may define an action constant, e.g., “action edit” and the action corresponding to the intent may be “display data for the user to edit.”

Action 205 may include a command provided to another client device 102b via an advertisement. Action 205 may be displayed within an advertisement as a command to client device 102b to perform a task directed from client device 102a. Client device 102a generates action 205 for client device 102b via module 203. Action 205 may include an attribute that signifies an act that the user of client device 102a wants the user of client device 102b to receive. Action 205 may be sharing information with the user of client device 102b about game application 204. Action 205 may include, but is not limited to, a challenge, a notification, an invitation, a post, etc. In some implementations, action 205 may also include an annotation that has been associated with the user. The annotation may be a remark that the user provides regarding the game of game application 204. The annotation may be a text string or in another standardized format. The annotation may include a user rating, recommendation, favorite, bookmark, etc. The annotation may also include a personalized rating, statement, etc. by the user.

Client identifier 208 may store information about game application 204, client device 102a, or module 203. In some implementations, a request for the intent may include client identifier 208. Client identifier 208 may include an expiration time, e.g., after a user session has ended with game application 204. Client identifier 208 may include encrypted data from the user, such as the user's game account, game ID (e.g., user name/handle), etc. In some implementations, a user of client device 102a may opt-out of providing client identifier 208. For example, if an opt-out is selected, then information about game application 204 may not be collected to be used to select advertisements to be provided to client device 102b.

Application identifier 207 may store information about game application 204. In other implementations, application identifier 207 may include multiple application identifiers. For example, if client device 102a includes more than one application. Application identifier 207 may be provided from an external document, such as, but not limited to, a web page, a web server, etc. Application identifier 207 may include an application code (e.g., encryption key), application URL, etc.

Social networking application 209 may receive action 205, client identifier 208, application identifier 207, and any other information from game application 204. Social networking application 209 may be a background process that is called by the intent. For example, social networking application 209 may have a portion of code which provides a user interface integrated within game application 204 or game website to provide and/or receive information (e.g., user-related data) between game application 204 and a social networking website. Alternately, when background calls cannot be made (e.g., an application cannot invoke another application as a background process) as in some computer systems, a compiled library may perform the same or similar tasks. For the compiled library to perform the same tasks as the background service, the API may need to obtain an authentication (e.g., OAuth) token from the social networking application or website. The authentication token may be similar to a cookie, e.g., the library may ask the user for permission. The token may then be used to receive social annotations on behalf of the user. In some implementations, game application 204 may invoke social networking application 209 when game application 204 is initiated. In some implementations, social networking application 209 and game application 204 are web applications. Social networking application 209 may provide user-related information in the form of user identifier 211.

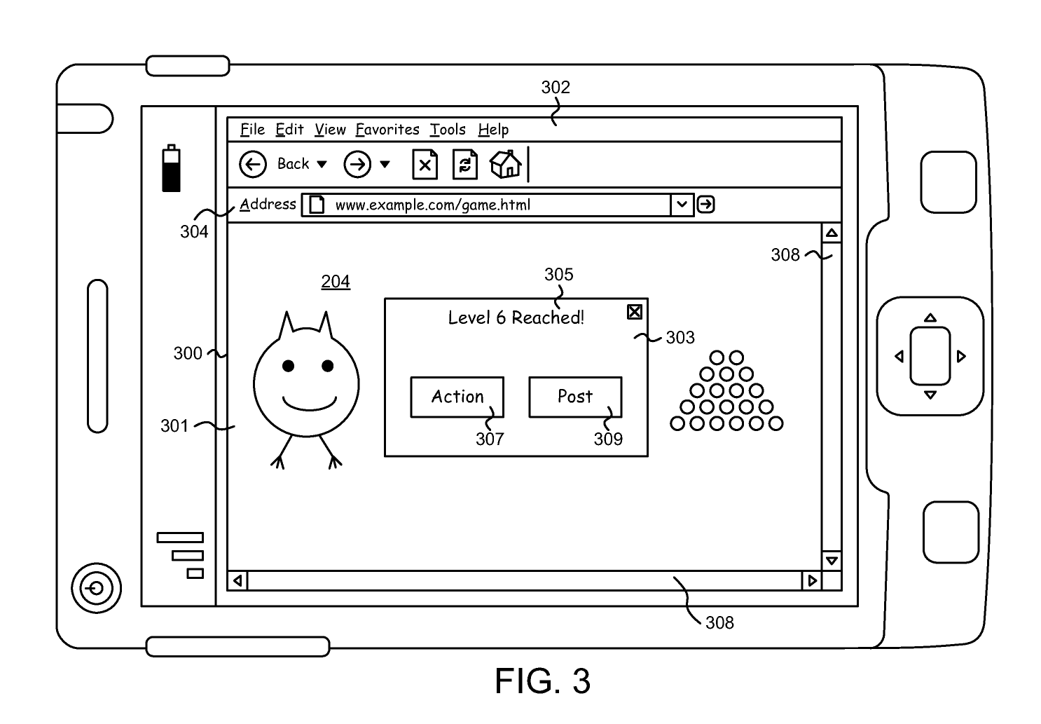

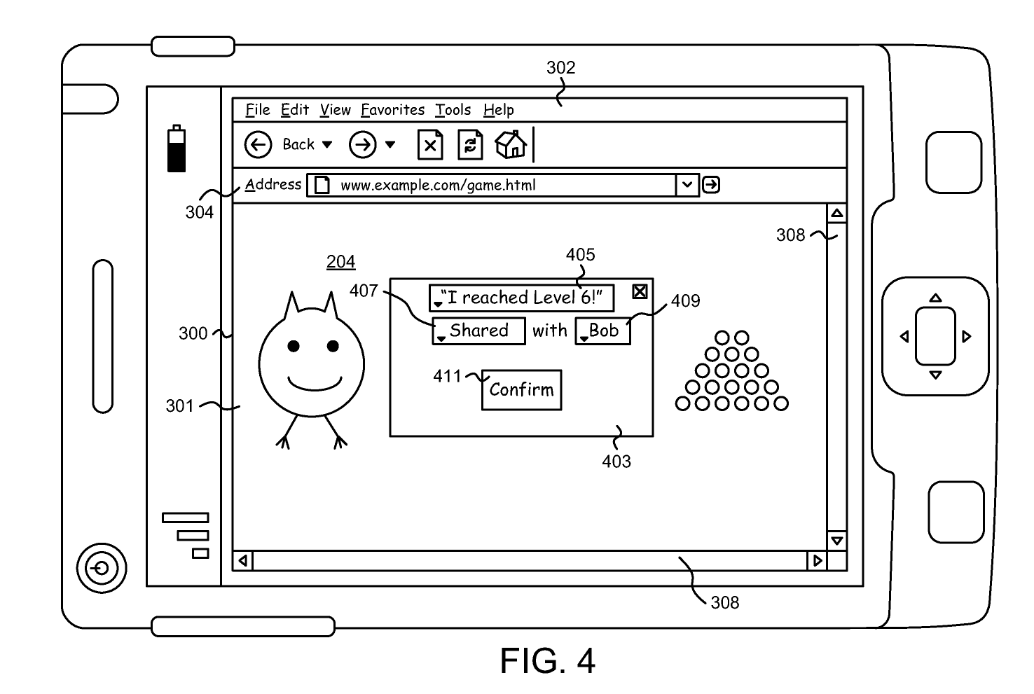

User identifier 211 may include information and/or data regarding the user's profile data, social networking data, etc. If the user is logged into client 102a, social networking application 209 may access user identifier 211. In some implementations, the user, via client 102a, may log into network 106 and/or social networking application 209 to access the social network. The user may opt out of allowing access to user identifier 211. For example, user identifier 211 obtained from social networking application 209 may include whether the user associated with user identifier 211 has permitted the use of user identifier 211 for purposes of advertising. User identifier 211, application identifier 207, action 205 and any other information from client device 102a may be provided to server 104 via network 213. In some implementations, the user of client device 102a may confirm action 205, i.e., the transmittal to server 104, via confirmation screens 303, 403 as described in FIGS. 3 and 4.

### Example Interfaces

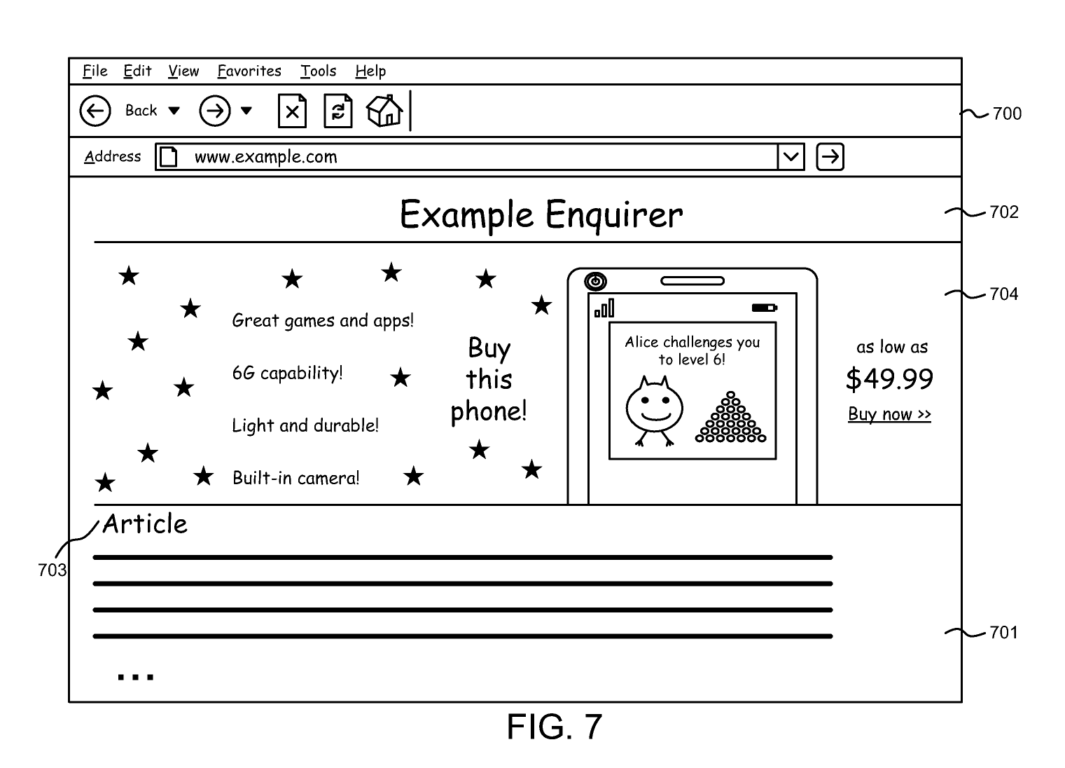

FIG. 3 is an illustration of a display 300 of a user interface in accordance with a described implementation. To provide for interaction with the user, the implementations described may be implemented on client device 102 having a browsing application. The browsing application may include a rendered web page that is provided by display 300. Browsing application is described herein, with reference to FIG. 7. Display 300 may include images, video, audio, etc. from game application 204.

Display 300 is in electronic communication with one or more processors that cause visual indicia to be provided on display 300. Display 300 may be located inside or outside of the housing of the one or more processors. For example, display 300 may be external to a desktop computer (e.g., display 300 may be a monitor), may be a television set, or any other stand-alone form of electronic display. In another example, display 300 may be internal to a laptop computer, mobile device, or other computing device with an integrated display.

As shown in FIG. 3, the one or more processors in communication with display 300 may execute a web browser application (e.g., display 300 is part of a client device). The web browser application operates by receiving input of a uniform resource locator (URL) into a field 302, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide webpage data and/or other data to the client device, which causes visual indicia to be displayed by display 300.

In general, webpage data may include text, hyperlinks, layout information, and other data that is used to provide the framework for the visual layout of displayed webpage 301. In some implementations, webpage data may be one or more files of webpage code written in a markup language, such as the hypertext markup language (HTML), extensible HTML (XHTML), extensible markup language (XML), or any other markup language. For example, the webpage data in FIG. 3 may include a file, “game1.html” provided by the website, “www.example.com.” The webpage data may include data that specifies where indicia appear on webpage 301, such as game 204 or other visual objects. In some implementations, the webpage data may also include additional URL information used by the client device to retrieve additional indicia displayed on webpage 301.

The web browser providing data to display 300 may include a number of navigational controls associated with webpage 301. For example, the web browser may include the ability to go back or forward to other webpages using inputs 304 (e.g., a back button, a forward button, etc.). The web browser may also include one or more scroll bars 308, which can be used to display parts of webpage 301 that are currently off-screen. For example, webpage 301 may be formatted to be larger than the screen of display 300. In such a case, one or more scroll bars 308 may be used to change the vertical and/or horizontal position of webpage 301 on display 300.

In one example, additional data associated with webpage 301 may be configured to perform any number of functions associated with game 204. For example, the additional data may include a web-based game application 204, which is used to play the game. Game application 204 may be called in any number of different ways. In one implementation, game application 204 may be an application installed on the client device and launched when webpage 301 is rendered on display 300. In another implementation, game 204 may be part of a plug-in for the web browser. In another implementation, game application 204 may be part of the webpage data downloaded by the client device. For example, game application 204 may be a script or other form of instruction that causes game 204 to load on display 300. Game application 204 may also include a number of controls, such as buttons that allows game 204 be played or paused.

The various functions associated with an advertisement provided to another client device 102b may be implemented by including one or more advertisement tags within the webpage code located in “game.html” and/or other files. For example, “game.html” may include an advertisement tag that specifies the location, an action, an annotation, etc. Another advertisement tag may request an advertisement from a remote location, for example, from an advertisement server, as webpage 301 is loaded. Such a request may include one or more keywords or other data used by the advertisement server to select an advertisement to provide to the client. According to some implementations, one or more characteristics of the webpage may be provided to the advertisement server as part of the request for an advertisement. In other implementations, the advertisement server may request the webpage directly, to determine its characteristics.

In some implementations, webpage 301 includes a confirmation screen 303. Confirmation screen 303 may be displayed as a separate window within webpage 301. In some implementations, the confirmation screen is displayed as an overlay. In some implementations, confirmation screen 303 is displayed on web page 301 after a goal is reached within game application 204. For example, as shown in FIG. 3, confirmation screen 303 is displayed after accomplishment 305 (e.g., level 6) is reached by the user. In some implementations, confirmation screen 303 is displayed by default. In other implementations, confirmation screen 303 is displayed pursuant to a user directive, for example which can be set in an “options” menu. For example, the user may want confirmation screen 303 to appear after every sublevel.

Confirmation screen 303 may include a variety of input fields for the user. For example, in FIG. 3, the user may select input field 307 and/or input field 309. Post 309 may allow the user to communicate accomplishment 305 to another user, for example via the social networking application, or to a website or webpage, etc. Confirmation screen 303 may be a pre-submission confirmation screen prior to confirmation screen 403 in FIG. 4 if input field 307 is selected.

FIG. 4 is another example illustration of a display 300 of in accordance with a described implementation. Confirmation screen 403, provided in response to the user selection of action 307, may be presented by a “client,” e.g. in a web browser. The confirmation screen 403 may also be presented in a client computer program that is capable of presenting a user interface. The client (whether implemented, e.g., as being displayed in a web browser or as a client computer program or in any other appropriate manner) may also be capable of receiving/accepting user interaction from the user. The client may be instantiated on a variety of mobile and/or tethered computing devices, e.g., personal computers, laptop computers, mobile computers, tablet computers, workstations, electronic games, media players, mobile phones, combinations of these and/or other appropriate computing devices. The client may be implemented in software, hardware, firmware, combinations of these, etc.

Confirmation screen 403 may include user interface elements such as input fields 405, 407, and 409. Input field 405 is configured to receive an annotation that may be specified by the user. Input field 405 may include a text box, drop down menu, or any other appropriate design to receive an annotation. Input field 405 may receive a number of annotations, including, but not limited to, like, recommend, don't play, boring, and any other rating input.

Input field 407 is capable of receiving an action that may be specified by the user. Input field 407 may include a text box, drop down menu, or any other appropriate design to receive an action. Input field 407 may receive a number of actions, including, but not limited to, sharing the information with another user, challenging another user, inviting another user to play the game, reviewing the game for another user, etc. Input field 409 is capable of receiving an identifier of a user with whom the user would like to direct the information to. Input field 409 may include a text box, drop down menu, or any other appropriate design to receive an identifier of a user. The user interface elements may also include confirm selector 411, which may be used to submit the information. Confirm selector 411 may include a button, a link, hotspot (e.g., shading, outline, etc.), a selectable item on a menu, identifiable gesture, identifiable utterance (e.g., voice recognition), etc. The user interface elements may be capable of receiving input from the user that allows the user to use functionality associated with the user interface elements. For example, confirm selector 411 may receive input (e.g., from a peripheral, such as a mouse, keyboard, etc.), and in response the annotation from input field 405 may be submitted to the advertisement server. Confirmation screen 403 may also be configured to include other user interface elements, which can provide additional or different information. User selection of confirm selector 411 causes the social networking application 209 to provide a request to the advertisement server with additional details provided from the user interface elements.

### Additional Example Systems

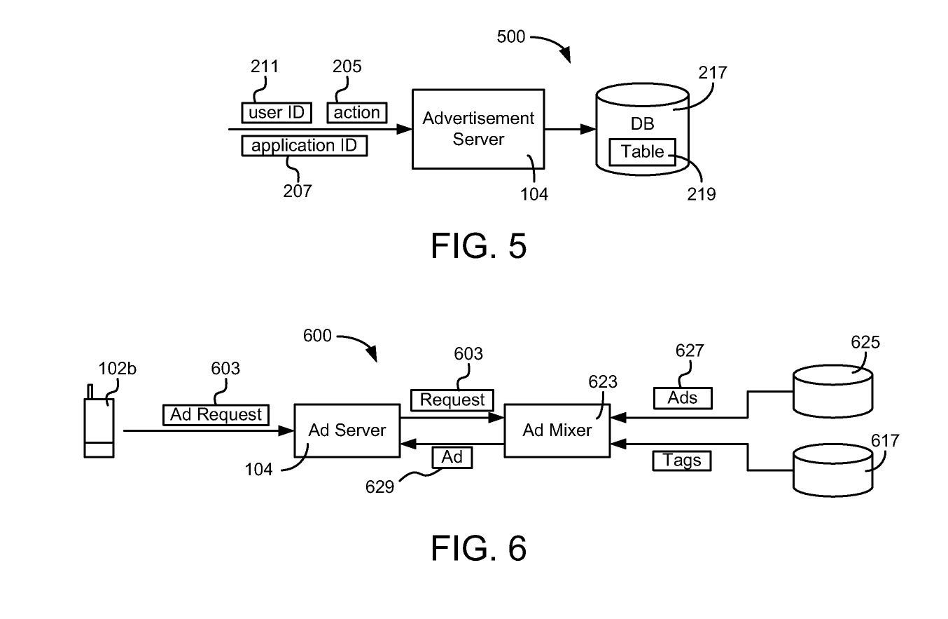

FIG. 5 is an illustration of a system 500 for storing and retrieving tags, keywords and other identifiers related to game application 204. As shown, user identifier 211, action 205, and application identifier 207 may be received by advertisement server 104.

The server may associate these indicators/identifiers (e.g., action, annotation, etc.) through a “tagging” process, by which the server 104 assigns tags to the identifiers. The tags may be stored within table 219 in database 217 for later retrieval. The organization of tags may be preserved when synchronizing the tags among browsers. In some implementations, the user may manually synchronize server-side tags for actions, annotations into client-side browser tags for actions, annotations, etc. For example, the user may manipulate the annotation associated with the game.

Table 219 may be designed to be sorted by user identifier 211 or action 205 along with a corresponding tag. An advertisement may be selected based on at least a tag associated with one of the identifiers. Database 217 may store table 219 using a relational model, a hierarchical model, a network model, or any other model for storing indictors along with a tag. Database 217 may be searchable. For example, user identifier 211, action 205, may be associated, correlated and classified with a tag. Table 219 may be sorted and searched by any identifier (e.g., by tag) to provide retrieval by advertisement server 104.

FIG. 6 illustrates an advertising system for providing advertisements with annotated advertisements. In advertising system 600, an input device, such as a mouse, is configured to interact with a document (e.g., website, webpage, other content) from a content source presented by a display. The display may be implemented using a web browser. The display may be implemented by an electronic game. The display may be configured to run the electronic game within the web browser.

Advertisement request 603 may be provided to advertisement server 104 from client device 102b. In some implementations, advertisement request 603 may be provided to advertisement server 104 from a content source that receives requests for documents (e.g., website, webpages, articles, discussion threads, search results, etc.). Advertisement request 603 may include the number of ads desired, document request information (e.g., page itself, category, topic, age, type, geographical information, etc.)

Advertisement request 603 may be provided to advertisement mixer 623. Advertisement mixer 623 may be a component of advertisement server 104, other third party advertising server, etc. Advertisement mixer 623 queries database 625 for advertisements and database 617 for matching tags. Advertisement mixer 623 may receive advertisements and tags. Advertisement mixer 623 may match the tags to a suggested advertisement from the advertisement database 625 and/or may optionally rank the advertisements according to an auction function.

The auction function may determine advertisements that will be selected for display to the user. The auction function may determine a ranking for each advertisement dependent on the advertisement, a query, etc. For example, information associated with the advertisement such as content, bid, position, ad quality, etc. may generate an index that can be used for ranking the advertisement prior to a query. When a query or content request is received at advertising server 104, then the auction function via a selection process sorts the index and predicts which advertisements will likely have a high ranking, then calculates the ranking of these advertisements and takes into account the query only for the advertisements that are predicted to have a high ranking.

The best ads can be identified based on the auction function. In some examples, the auction function depends both on the quality of the ad (which affects the probability that users will click on the ad) and what an advertiser bids for the ad. An advertiser whose ad is not very good but bids very high may obtain the same position in the auction as another advertiser whose ad is very good but does not bid as high.

In some implementations, the selection of the matching advertisement by advertisement mixer 623 is based on determining a relevance score for each matching advertisement. The relevance score of each matching advertisement may be computed for each advertisement representative of a relationship between each matching advertisement and the request by the first user. For example, the relevance score may vary based on the degree of matching, with the largest relevance score for a complete match between the request from the first user and the tags created by the advertiser. When the best match is only a partial match, e.g., the request from the first user matches only one of the tags of multiple tags, then the relevance score is less than the predefined largest value, and reflects the degree of the match.

For a document, system 600 may determine a baseline probability, which is a baseline auction score that depends on the document and its bid. The baseline score does not depend on the query. Information other than the bid amount such as information related to the advertisement (e.g., content, position, etc.), in which the information can be obtained prior to receiving a query, can also be incorporated in the auction function and used in calculating the baseline auction score. The baseline auction score may be increased by matching tags from database 617 to generated advertisements from database 625. In some implementations, where there is an association with tags (or labels), the most relevant advertisement may be determined by locating an advertisement(s) that is associated with the tag. For example, the tag may be a textual keyword, phrase, etc. which describes or is associated with portions of the game content that has been delineated by a user. The tag may then be used to create an association with an advertisement. For example, if a user who selects “share information that I reached level six with Bob,” then Bob will be presented with particular kinds of relevant ads, such as those promoting the game and relevant content.

In another example, if an advertiser had entered “Bird Game” in the tags on their creative/advertisement, then the auction score would be increased in the advertisement auction based on matching the tag representative of an action directed by the first user to the second user.

In another example, if the advertiser had entered targeting criteria based at least in part on a user playing games, then the auction score would also be increased in the advertisement auction based on matching the action tag. In an alternative implementation, ads are not submitted to the auction as candidate advertisements for the auction unless a keyword or tag from the user's action matches a keyword or tag of the advertisement.

Advertisement mixer 623 may transmit additional information related to the advertisement. For example, the information may include the annotation (e.g., a social networking rating input). The annotation may be stored within another server/domain. Client device 102b may make a call to the social networking application to determine an annotation(s) to provide to advertisement mixer 623. Advertisement mixer 623 scans the advertisements provided by database 625, maps the inventory of advertisements, optimizes the annotations along with advertisement request 603, matches the tags with the generated advertisements, and selects an advertisement based at least on the match. Advertisement mixer 623 may provide the candidate advertisement to advertisement server 104. Advertisement server 104 may be configured to serve ads to user device 102b. The advertisement(s) may be served in association with search results provided by a search engine. In some implementations, content-related advertisement(s) may be provided in association with content provided by the content sources. In some implementations, the content sources may combine a requested document with an advertisement provided by advertisement server 104. The information including the document information and the advertisement(s) is provided to the user device 102b that requested the document, for display to the user. The content source may provide information about the advertisement(s) (e.g., size, number, position, click, impression information, size, conversion, etc.) back to advertisement server 104. In some implementations, client device 102b may request an advertisement and combine them with content or search results.

### Additional Example Interfaces

FIG. 7 is an example of a web page providing an advertisement to a second user in accordance with a described implementation. Example web page 700 shows content 701 that may be available from a content source (e.g., content provider, publisher, etc.). As shown, content 701 may be configured to be displayed on a desktop computer. Content 701 includes a content title 702, a main article 703, and an advertisement 704. Advertisement 704 may be displayed as an online advertisement, as shown in FIG. 7. Advertisement 704 may include features that are specified by an application, the advertiser, the publisher, etc. For example, the advertisement may be a text advertisement with a title line, text related to the product, embedded information (e.g., a hyperlink), etc. In another example, as shown in FIG. 7, advertisement 704 may be a banner ad (web banner), which include an embedded advertisement 704 in web page 700.

Web page 700 is received by a second user's client device 102b from a content source 108, 110. Advertisement 704 displayed on the client device 102b is received from the advertisement server 104 and displayed on web page 700. Advertisement 704 may be included within an advertisement for the game, another product (e.g., a mobile device as shown in FIG. 7), etc. For example, the advertisement for mobile device company includes the annotated advertisement provided by Alice, “Alice challenges you to Level 6!” In some implementations, the advertisement may include text, images, video, etc. To provide the annotation on the advertisement, the content source 108, 110 reads action table 219 stored in database 217 and displays the correct annotation on advertisement 704.

### Example Processes

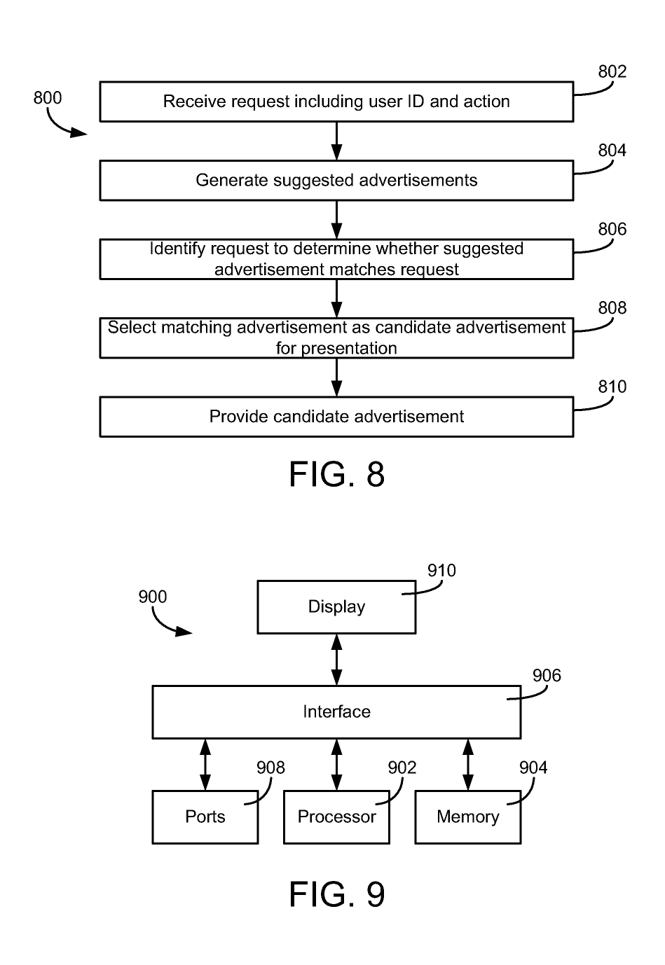

FIG. 8 is a flow diagram of a method for providing annotated advertisements based on actions from social networking sites in accordance with a described implementation. The method 800 is provided by way of example, as there are a number of ways to carry out the methods according to the present disclosure. The method 800 shown in FIG. 8 may be executed or otherwise performed by one of a combination of various systems. The method 800 may be implemented by a computer, a computer program product, a client, a server, a client-server relationship, etc. The method 800 is described herein as carried out by the illustrated implementations of FIGS. 1 and 9, by way of example.

Example method 800 begins at block 802, in which a request from a first user directed to a second user is received. For example, Alice may be playing a game on her mobile computing device via a game application. While Alice is playing the game or during other appropriate intervals such as intermissions between levels, end of the game, etc., the game may be configured to present Alice with the opportunity to provide an action request to another user. A confirmation screen may appear prompting Alice to share with, challenge, etc. another user who is related to Alice on a social networking website. For example, if Alice reaches a certain level, the game application may display a prompt: “Alice, do you want to challenge a friend?” The game application may provide a list of users via the social networking interface that Alice may select from. Alice may select a second user, Bob, to challenge.

The system may generate a request, which may include a second user identifier and an action tag provided by the first user. The action tag may further include an annotation (e.g., rating, remark, etc.) written by Alice. In the above example, the second user identifier becomes Bob's user information and the action tag becomes challenge. The second user identifier may include the second user's information. The system may extract the second user identifier and the second user's information from, e.g., a personal cookie, a social networking identifier, a limited identifier cookie, etc. The social networking identifier may include information from the user's social networking account, which may keep track of the second user's presence in social networks. The user and/or social contacts of the user may opt out of the tracking at any time. The second user identifier may also include a limited identifier, which may not be decrypted by other third party services and/or applications, but used for advertisement targeting. In some implementations, the limited identifier allows the advertisement system 200 to provide candidate advertisements that are targeted to the second user without access to the second user's personal information.

The second user identifier may be verified against a table to determine its authenticity. Once the second user identifier is determined to be authentic, the second user's information may be obtained. The second user's information may be subject to privacy controls by the second user, e.g., the second user associated with the second user identifier may not permit the use of their user information for advertisement targeting.

At block 804, a suggested advertisement is generated based at least on data that is part of the request. The suggested advertisement may be generated in response to the second user viewing, browsing and/or interacting with a webpage via their mobile computing device 102b. The second user's mobile computing device 102b may submit an advertisement request to advertisement server 104.

Advertisement server 104 may communicate with advertisement mixer 623 to generate a suggested advertisement. For example, advertisement server 104 may initially check with the advertisement mixer 623 to determine whether an advertisement matches the second user's information. In some implementations, the suggested advertisement for the second user may include an advertisement related to the second user's interest profile stored in the second user identifier.

At block 806, the request from the first user is identified to determine whether the suggested advertisement matches the request. Advertisement mixer 623 accesses database 617 and advertisement database 625. The advertisement mixer 623 may retrieve tags and actions from database 617. For example, the tags (Bob, Alice, Level Six, Bird Game) and actions (challenge) may read “Bob, Alice challenges you to reach level six in Bird Game” along with the advertisement. Advertisement mixer 623 may then review the suggested advertisement to see whether it matches both the second user and the results of an auction. The first user's request may be “Bob, Alice challenges you to reach level six in Bird Game.” The suggested advertisement may be for the game “Bird Game.” Here, the suggested advertisement matches the request so advertisement mixer 623 provides advertisement 629 to the advertisement server as a candidate advertisement.

At block 808, a matching advertisement is selected as a candidate advertisement for presentation to the second user. Advertisement mixer 623 may select the matching advertisement based on second user identifier 211, action tag 205, and the first user's request. In some implementations, the matching advertisement may be selected as a candidate advertisement based on whether a bid associated with the matching advertisement is higher than bids associated with other matching advertisements.

For example, an advertiser may enter “Bird Game” as a keyword, create a rule regarding “Bird Game”, etc. Advertisement mixer 623 may review the information from the tags and annotations from the advertisement to determine the relevance score, a quality score, a probability, etc. for the auction function. Therefore, the bid associated with this advertisement will be higher than another advertisement with, for example, for an ad using “game” as a keyword. The advertiser may enter additional tags and/or rules to filter various matching advertisements.

At block 810, the candidate advertisement may be provided to the second user. The candidate advertisement may include data indicative of the action tag. For example, the data may include information related to the second user, including, but not limited to, the second user's name, avatar, ID handle, etc. The data may include information related to the first user, including, but not limited to, the first user's name, avatar, ID handle, etc. The data may include a challenge by the first user. The data may include an invitation by the first user.

Method 800 may also include providing an incentive to the first user for providing a request. “Providing” a credit may include, in various implementations, calculating a credit or other thing of value (e.g. coupon, etc.), applying a credit to an account, transmitting a credit to an account on a server to be applied at the server, etc. In some implementations, the incentive is based on interaction with the candidate advertisement. For example, if the second user clicks, highlights, views, etc. the advertisement, then the first user receives an incentive.

### Example Devices

FIG. 9 is a block diagram of a computing device 900 that may be used to implement the systems and methods in accordance with the described implementations, as either a client or as a server or plurality of servers. Computing device 900 may include, but is not limited to, digital computers, such as laptops, desktops, workstations, personal digital assistants, servers, blade servers, mainframes, cellular telephones, smartphones, mobile computing devices (e.g., a notepad, e-reader, etc.) etc.

Computing device 900 includes a processor 902, memory 904, an interface 906 and ports 908. Each of the components 902, 904, 906, and 908, are interconnected using various busses, and may be mounted on a common motherboard or in other manners as appropriate. The processor 902 can process instructions for execution within the computing device 900, including instructions stored in the memory 904 to display graphical information for a GUI on an external input/output device, such as display 910 coupled to interface 906.

In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, a multi-processor system, etc.). The ports 908, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 902 may provide, for example, for coordination of the other components of the device 900, such as control of user interfaces, applications run by device 900, and wireless communication by device 900. Processor 902 may communicate with a user via interface 906 (e.g., control, display, external, etc.), coupled to a display 910. The display 910 may be, for example, a TFT (Thin-Film-Transistor Liquid Crystal Display) display, an OLED (Organic Light Emitting Diode) display, other flexible display, etc. The interface 906 may include circuitry for driving the display 910 to provide graphical, textual, and other information to a user. The interface 906 may receive commands (e.g., voice-activated, text, etc.), from a user and convert them to provide to the processor 902.

In addition, the interface 906 may be provided to communicate with processor 902 and enable near area communication of device 900 with other devices. The interface 906 may provide, for example, for wired communication. In some implementations, multiple interfaces may be used. Computing device 900 may communicate wirelessly through interface 906, which may include digital signal processing circuitry where necessary. Interface 906 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 900, which may be used as appropriate by applications running on device 900. The device 900 may also be provided with a storage device to provide additional storage, e.g., solid-state flash media. Each of the components may be interconnected using various buses. Several of the components may be mounted on a common motherboard or in other appropriate manners.

Device 900 may communicate audio feedback. In some implementations, an audio codec may receive spoken information from a user and convert it to usable digital information. The audio codec may generate audible sound for a user, such as through a speaker, e.g., in a handset of device. Sound(s) may include sound from voice telephone calls, recorded sound (e.g., voice messages, music files, etc.), sound(s) generated by applications operating on device, etc.

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk. The memory 904 may be capable of providing mass storage for the computing device 900. In one implementation, the memory 904 may be or contain a computer-readable medium, such as a floppy disk device, a hard disk device, an optical disk device, or a tape device, a flash memory or other similar solid state memory device, or an array of devices, including devices in a storage area network or other configurations.

A computer program product may be tangibly embodied in an information carrier. The computer program product may also contain instructions that, when executed, perform one or more methods, such as those described above. The information carrier is a computer or machine-readable medium, such as the memory 904, memory on processor 902, a propagated signal, etc. Expansion memory may be provided and connected to device 900 through interface 906.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, or software embodied on a tangible medium, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Features described under one heading are not required to be used together in implementations, and features described under separate headings may be used together in various implementations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for providing an advertisement based on an action directed by a first user to a second user, comprising:
receiving, using one or more computing devices, a request from a first user directed to a second user, wherein the request comprises a second user identifier and an action tag, the action tag representative of an action directed by the first user to the second user;
generating, using the one or more computing devices, a candidate advertisement based at least on data that is part of the request;
sending, using the one or more computing devices, the candidate advertisement to an advertisement mixer, the advertisement mixer configured to receive a request for an advertisement;
selecting, using the advertisement mixer, an advertisement from among a plurality of candidate advertisements for presentation to the second user; and
providing the selected advertisement to the second user.

2. The method of claim 1, wherein selecting the advertisement for presentation to the second user is based on bids associated with the plurality of candidate advertisements.

3. The method of claim 1, wherein selecting the advertisement for presentation to the second user is based on a relevance score for each of the plurality of candidate advertisements, the relevance score representing how relevant the advertisement is to the request for the advertisement.

4. The method of claim 1, further comprising storing a relationship between the first user and the second user at a social networking web site.

5. The method of claim 1, wherein data in the request from the first user comprises an application identifier of an application operating on a computing device within which the request was generated, wherein the candidate advertisement is generated based on the application identifier.

6. The method of claim 5, wherein the action tag represents a challenge by the first user to the second user, the challenge representing a goal to be achieved in the application.

7. The method of claim 1, wherein the action tag represents an invitation by the first user to the second user.

8. The method of claim 1, further comprising providing an incentive to the first user for creating the action tag directed to the second user.

9. The method of claim 8, wherein providing the incentive is based on interaction with the candidate advertisements by the second user.

10. A system for providing an advertisement based on an action directed by a first user to a second user, comprising:
a tangible computer-readable storage device comprising instructions; and one or more processors coupled to the tangible computer-readable storage device and configured to execute the instructions to perform operations comprising:
receiving a request from a first user directed to a second user, wherein the request comprises a second user identifier and an action tag, the action tag representative of an action directed by the first user to the second user;
generating a candidate advertisement based at least on data that is part of the request;
sending the candidate advertisement to an advertisement mixer, the advertisement mixer configured to receive a request for an advertisement;
selecting, using the advertisement mixer, an advertisement from among a plurality of candidate advertisements for presentation to the second user; and
providing the selected advertisement to the second user.

11. The system of claim 10, further configured to select the advertisement for presentation to the second user based on bids associated with the plurality of candidate advertisements.

12. The system of claim 10, wherein selecting the advertisement for presentation to the second user is based on a relevance score for each of the plurality of candidate advertisements, the relevance score representing how relevant the advertisement is to the request for the advertisement.

13. The system of claim 10, further configured to store a relationship between the first user and the second user at a social networking website.

14. The system of claim 10, wherein data in the request from the first user comprises an application identifier of an application operating on a computing device within which the request was generated, wherein the candidate advertisement is generated based on the application identifier.

15. The system of claim 10, wherein the action tag represents a challenge by the first user to the second user, wherein the challenge represents a goal to be achieved using the application.

16. The system of claim 15, wherein the action tag represents an invitation by the first user to the second user.

17. The system of claim 10, further comprising providing an incentive to the first user.

18. The system of claim 10, wherein providing the incentive is based on interaction with the candidate advertisement by the second user.

19. A computer-implemented method comprising:
receiving, at a computer server system, an action tag representative of an action directed by a first user to a second user, wherein the action tag comprises at least one of a sharing action from the first user to the second user;
receiving, at the computer server system, an application identifier representative of an application operating on a computing device of the first user. generating a candidate advertisement based on the action tag and the application identifier;
sending the candidate advertisement to an advertisement mixer, the advertisement mixer configured to receive a request for an advertisement;
selecting, using the advertisement mixer, an advertisement from among a plurality of candidate advertisements for presentation to the second user; and
providing the selected advertisement to the second user.
